(19) United States
(12) Patent Application Publication
(10) Pub. No.: US 2007/0264597 A1
(43) Pub. Date: Nov. 15, 2007

(54) Method for manufacturing transflective liquid crystal display

(75) Inventor: Jian-Jhong Fu, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/803,448

(22) Filed: May 14, 2007

(30) Foreign Application Priority Data
May 12, 2006 (TW) 95116845

(51) Int. Cl. G03C 5/00

(52) U.S. Cl. 430/318

(57) ABSTRACT

An exemplary method for fabricating a transflective liquid crystal display device includes: (1) forming a first metal layer on a substrate and conducting a lithography and etching process so as to define a gate and protrusions within a thin film transistor (TFT) region and a reflection region separately; (2) forming a gate insulator over the substrate; (3) forming a semiconductor pattern within the TFT region; (4) forming a source and a drain of the thin film transistor; (5) forming a passivation layer and a contact hole so as to expose the drain through the contact hole; and (6) forming a transmission pixel electrode within a transmission region and a reflection pixel electrode within the reflection region.

### BACKGROUND OF THE INVENTION

1. Field of the Invention

The invention relates to methods for manufacturing liquid crystal display (LCD) device, and particularly to methods for manufacturing LCD device having a transmission region and a reflection region in each pixel.

2. General Background

Along with the rapid advance in technology, the role that reflective TFT-LCD (Thin Film Transistor-LCD) panel and transflective TFT-LCD panel has played in the market has become ever more important. In the industry of telecommunication, the transflective TFT-LCD panel can be applied to the display screen of a mobile phone, allowing the users to clearly read their display screens whatever the illumination is dark at a chamber or extreme bright in the open air.

Recently, in order to effectively reduce steps for manufacturing transflective LCD device, a slit mask is used in the lithography process. The general manufacturing process is illustrated below. Firstly, four normal masks are applied sequentially in the lithography processes over the substrate that TFTs can be fabricated on the substrate. Meanwhile, at least one transmission region and one reflection region are defined on the substrate. Secondly, a passivation layer is deposited over the TFT structure. Subsequently, a pixel electrode, a buffer layer, and a reflector are formed sequentially on the passivation layer. Then a photo-resist layer is deposited on the reflector and the slit mask is adopted to apply the lithography process. Therefore, by applying the slit mask, the thickness of the photo-resist layer corresponding to the reflection region is thicker than that of the transmission region.

Subsequently, an ashing process is applied to the photo-resist layer so as to eliminate the photo-resist layer within the transmission region. Otherwise, some portions of the photo-resist layer still exist within the reflection region. Afterward, an etching process is performed to etch the buffer layer and the reflector within the transmission region that the pixel electrode can be exposed. Consequently, the remaining photo-resist layer within the reflection region is removed so as to expose the reflector (also known as “reflection electrode”) within the reflection region.

In the aforesaid processes, the slit mask is widely used by utilizing different light exposure rate that the reflection electrode and the transmission electrode can be formed during the same process. Hence, the lithography process can be simplified and the amount of masks can also be reduced. Nevertheless, the way we use slit mask can only control the thickness of the photo-resist layer rather than control the shape of the photo-resist layer. Therefore, the reflection electrode can only be shaped as a plane structure, which has a lower index of reflection. This means the display quality in the reflection regions of the transflective LCD device is liable to be inferior.

### SUMMARY

An exemplary method for fabricating a transflective liquid crystal display device comprises: providing a substrate defining a thin film transistor region, a transmission region, and a reflection region; forming a first metal layer and a first photo-resist layer on the substrate sequentially; applying an exposing process on the first photo-resist layer through a first mask and developing the first photo-resist layer; and etching the first metal layer through the developed first photo-resist layer so as to form a gate of the thin film transistor and a plurality of protrusions within the reflection region.

Subsequently, the exemplary method further comprises: forming a gate insulator on the substrate so as to cover the gate and the protrusions; forming a semiconductor layer and a second photo-resist layer sequentially on the gate insulator; exposing the second photo-resist layer through a second mask and developing the second photo-resist layer; etching the semiconductor layer through the developed second photo-resist layer so as to obtain a semiconductor pattern; forming a second metal layer and a third photo-resist layer over the substrate sequentially; exposing the third photo-resist layer through a third mask and developing the third photo-resist layer; and etching the second metal layer through the developed third photo-resist layer so as to form a source and a drain of the thin film transistor.

Consequently, the exemplary method further comprises: forming a passivation layer and a fourth photo-resist layer over the substrate sequentially; exposing the fourth photo-resist layer through a fourth mask and developing the fourth photo-resist layer; etching the passivation layer through the developed fourth photo-resist layer so as to expose the drain through a contact hole; forming a pixel electrode layer and a fifth photo-resist layer over the passivation layer sequentially; exposing the fifth photo-resist layer through a fifth mask and developing the fifth photo-resist layer; and etching the pixel electrode layer through the developed fifth photo-resist layer so as to form a transmission pixel electrode within the transmission region and a reflection pixel electrode within the reflection region.

Another exemplary method for fabricating a transflective liquid crystal display device comprises: providing a substrate defining a thin film transistor region, a transmission region, and a reflection region; forming a first metal layer and a first photo-resist layer on the substrate sequentially; applying an exposing process on the first photo-resist layer through a first mask and developing the first photo-resist layer; and etching the first metal layer through the developed first photo-resist layer so as to form a gate of the thin film transistor.

Subsequently, the other exemplary method further comprises: forming a gate insulator, a semiconductor layer and a second photo-resist layer sequentially on the substrate; exposing the second photo-resist layer through a second mask and developing the second photo-resist layer; etching the semiconductor layer through the developed second photo-resist layer so as to obtain a semiconductor pattern; forming a second metal layer and a third photo-resist layer over the substrate sequentially; exposing the third photo-resist layer through a third mask and developing the third photo-resist layer; and etching the second metal layer through the developed third photo-resist layer so as to form a source and a drain of the thin film transistor and a plurality of protrusions within the reflection region.

Consequently, the other exemplary method further comprises: forming a passivation layer and a fourth photo-resist layer over the substrate sequentially; exposing the fourth photo-resist layer through a fourth mask and developing the fourth photo-resist layer; etching the passivation layer through the developed fourth photo-resist layer so as to expose the drain through a contact hole; forming a pixel electrode layer and a fifth photo-resist layer over the passivation layer sequentially; exposing the fifth photo-resist layer through a fifth mask and developing the fifth photo-resist layer; and etching the pixel electrode layer through the developed fifth photo-resist layer so as to form a transmission pixel electrode within the transmission region and a reflection pixel electrode within the reflection region.

Other novel features and advantages of various embodiments of the present invention will become more apparent from the following detailed description when taken in conjunction with the accompanying drawings. In the drawings, all the views are schematic.

### BRIEF DESCRIPTION OF THE DRAWINGS

FIG. 1 to FIG. 13 are cross-sectional views of part of a transflective type thin film transistor (TFT) substrate of a liquid crystal display (LCD) device respectively illustrating the manufacturing steps according to a first exemplary embodiment of the present invention.

FIG. 14 to FIG. 19 are cross-sectional views of part of a transflective type TFT substrate of an LCD device respectively illustrating the manufacturing steps according to a second exemplary embodiment of the present invention.

FIG. 20 to FIG. 28 are cross-sectional views of part of a transflective type TFT substrate of an LCD device respectively illustrating the manufacturing steps according to a third exemplary embodiment of the present invention.

FIG. 29 and FIG. 30 are cross-sectional views of part of a transflective type TFT substrate of an LCD device respectively illustrating the manufacturing steps according to a fourth exemplary embodiment of the present invention.

### DETAILED DESCRIPTION OF PREFERRED EMBODIMENTS

Referring to FIGS. 1 to 13, these show cross-sectional views of part of a transflective type thin film transistor (TFT) substrate of a liquid crystal display (LCD) device respectively illustrating the manufacturing steps according to a first exemplary embodiment of the present invention. Firstly, as shown in FIG. 1, a transparent insulating substrate 200 is provided. Then, a first metal layer 210 is deposited on the substrate 200 defined with a TFT region 201, a transmission region 202 and a reflection region 203. In the preferred embodiment, the first metal layer 210 is a stacked multi-layer structure comprised of at least two layers, i.e. molybdenum (Mo), and aluminum-neodymium alloy (AlNd) or aluminum (Al). The etch rate of each of the stacked multi-layers for applying the same etching solution increases from bottom to top. Therefore, AlNd or Al should be at the bottom side and Mo is on the top of the stacked structure.

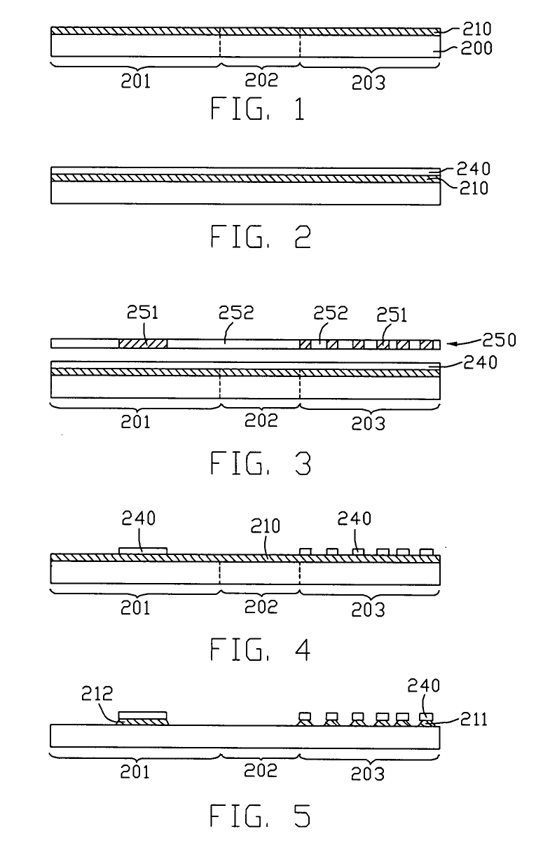

Subsequently, as shown in FIG. 2, a first photo-resist (PR) layer 240 is coated on the first metal layer 210. The coating method can be adopted by spin coating or spaying coating. As shown in FIG. 3, a first mask 250 is utilized in the lithography process so as to define a predetermined pattern over the first PR layer 240 through the first mask 250. The first mask 250 includes a first light shielding area 251 and a first light transmission area 252. One part of the first light shielding area 251 is set within the TFT region 201. The other part of the first light shielding area 251 and part of the first light transmission area 252 are set alternately corresponding to the reflection region 203. Additionally, the other part of the light transmission area 252 is directly located corresponding to the transmission region 202.

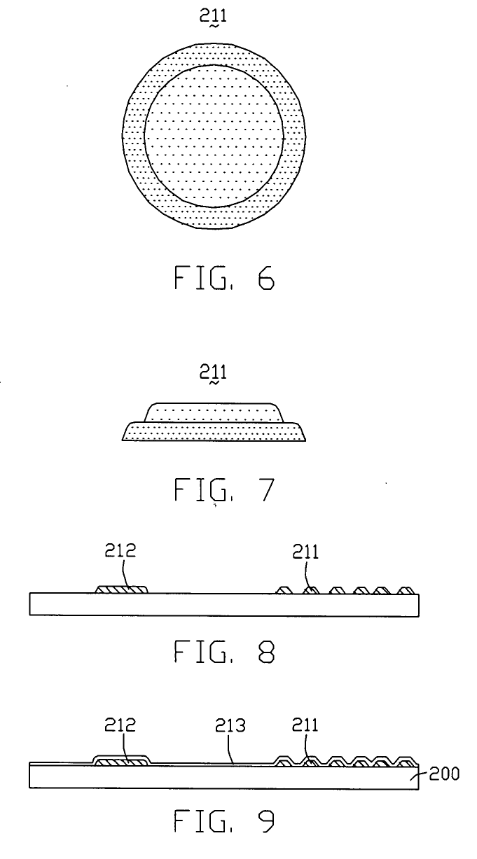

After the exposing and developing processes, as shown in FIG. 4, a first PR pattern is transformed from the first mask 250. As shown in FIG. 5, the first PR pattern is used as an etching mask such that a gate 212 is formed within the TFT region 201 and a plurality of protrusions 211 are formed within the reflection region 203 separately. The etching process can be used by wet etching or dry etching. For wet etching, the etching solution can be mixed with a substance such as hydrogen fluoride (HF) and/or ammonium fluoride (NH₄F). As shown in FIG. 6 and FIG. 7, because of the etch rate of each of the stacked multi-layers increases from bottom to top, the etched structure for each of the gate 212 and the protrusions 211 is like a truncated pyramid (i.e. a frustum).

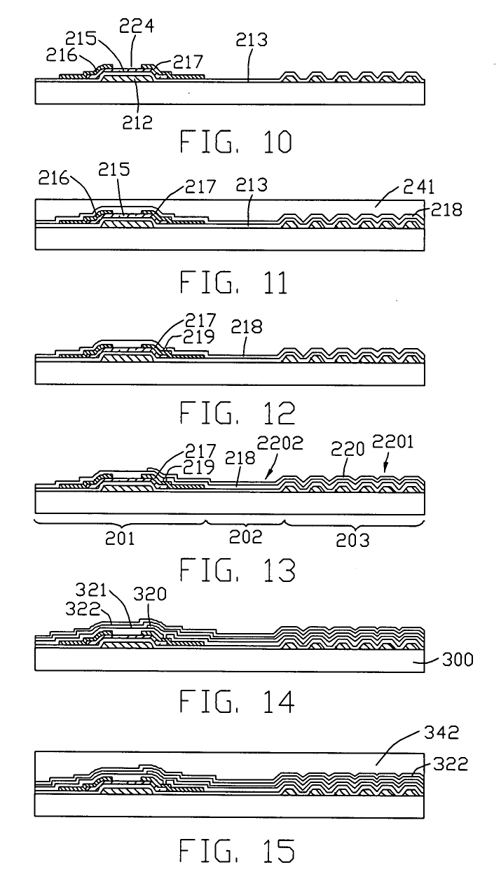

Afterward, as shown in FIG. 8, the remaining first PR layer 240 is ashed so as to expose the gate 212 and the protrusions 211. Then, as shown in FIG. 9, a gate insulator 213 is formed over the gate 212, the protrusions 211 and the substrate 200. The gate insulator 213 is deposited by the chemical vapor deposition (CVD) with a reaction gas. In particular, silane (SiH₄) and ammonia (NH₃) are used so as to form a silicon nitride (SiNₓ) structure. Next, as shown in FIG. 10, a semiconductor layer and a second PR layer (not shown) are deposited sequentially on the gate insulator 213. A second mask (not shown) is used in the lithography process and after the etching process a semiconductor pattern 215 can be obtained.

Subsequently, a source/drain (S/D) metal layer and a third PR layer (not shown) are deposited over the substrate 200. Usually, the S/D metal layer is a multi-layer structure comprised of Mo/AlNd/Mo (tri-layer) or Ti/Al/Ti (Ti, titanium). A third mask (not shown) is used in the following lithography process and after the etching process, a source 216 and a drain 217 can be obtained. A gap 224 is defined between the source 216 and the drain 217. As shown in FIG. 11, a passivation layer 218 and a fourth PR layer 241 are deposited over the substrate 200. A fourth mask (not shown) is used during the lithography process and after the etching process, whereby the drain 217 can be exposed through a contact hole 219 (shown in FIG. 12).

As shown in FIG. 13, a pixel electrode layer and a fifth PR layer are formed over the passivation layer 218 sequentially. The material of the pixel electrode layer can be chosen from indium tin oxide (ITO) or indium zinc oxide (IZO). A fifth mask (not shown) is utilized during the exposing process and after the developing and etching process, whereby a pixel electrode 220 can be formed. The pixel electrode 220 is electrically connected to the drain 217 through the contact hole 219 so as to define a reflection pixel electrode 2201 over the protrusion 211 within the reflection region and a transmission pixel electrode 2202 within the transmission region. Due to the uneven surface of the reflection pixel electrode constructed by the protrusion 211 in the reflection region 203 that the index of the reflection pixel electrode can be promoted.

Referring to FIGS. 14 to 19, these show cross-sectional views of part of a transflective type TFT substrate of an LCD device respectively illustrating the manufacturing steps according to a second exemplary embodiment of the present invention. According to above first embodiment, the second embodiment further includes the following steps. As shown in FIG. 14, a buffer layer 321 and a reflection metal layer 322 are formed sequentially over a transparent insulating substrate 300. A physical vapor deposition (PVD) method such as sputtering or evaporation can be used in this manufacturing process. The material of the reflection metal layer 322 can be chosen from aluminum (Al), argentums (Ag), or aluminum-neodymium alloy (AlNd). Additionally, the material of the buffer layer 321 can be chosen from Mo, Ti so as to separate the transmission pixel electrode 320 from the reflection metal layer 322.

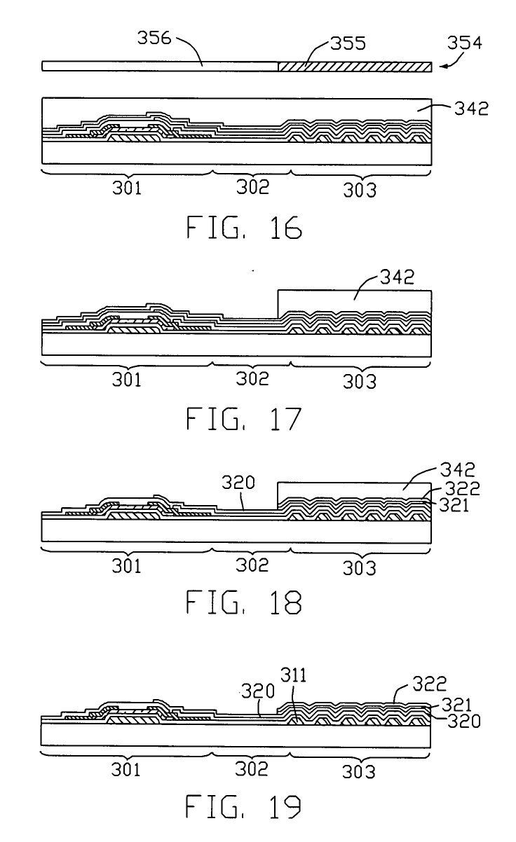

As shown in FIG. 15, a sixth PR layer 342 is coated over the reflection metal layer 322. Then, referring to FIG. 16, a sixth mask 354 is provided for expose the sixth PR layer 342 through the second light shielding area 355 (corresponding to the reflection region 303) and the second light transmission area 356 (corresponding to the TFT region 301 and the transmission region 302) so as to transform the mask pattern of the sixth mask 354 to the sixth PR layer 342. Consequently, as shown in FIG. 17, after the developing process, the portion of the sixth PR layer 342 corresponding to the TFT region 301 and transmission region 302 is eliminated, and a remaining portion of the sixth PR layer 342 corresponding to the reflection region 303 is preserved.

As shown in FIG. 18, an etching process is applied to the buffer layer 321 and the reflection metal layer 322 corresponding to the TFT region 301 and the transmission region 302. As shown in FIG. 19, the transmission pixel electrode 320 within the transmission region 302 and reflection metal layer 322 within the reflection region 303 are exposed after the ashing process is applied. According to this preferred embodiment, the reflection metal layer 322 is formed upon the uneven protrusions 311 within the reflection region such that the reflection efficiency for this transflective LCD can be elevated.

Referring to FIGS. 20 to 28, these show cross-sectional views of part of a transflective type TFT substrate of an LCD device respectively illustrating the manufacturing steps according to a third exemplary embodiment of the present invention. According to the above first embodiment, the difference between the first embodiment and the third embodiment is the uneven protrusions were made during the same process for manufacturing source/drain metal layer of the TFT structure. Details of the manufacturing processes are as follows:

Firstly, as shown in FIG. 20, a transparent insulating substrate 400 is provided. Then, a gate metal layer and a first PR layer (not shown) are deposited sequentially on the substrate 400 defined with a TFT region 401, a transmission region 402 and a reflection region 403. Therefore, lithography and etching processes are conducted that a gate 412 is define in the TFT region 402.

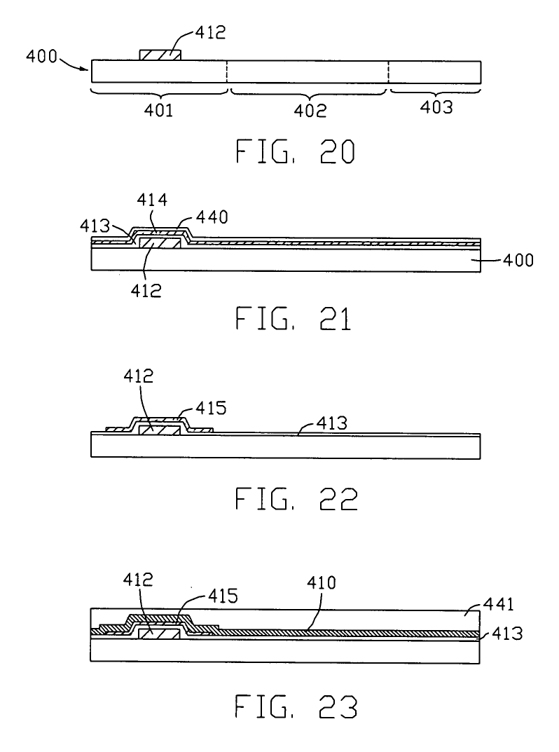

Subsequently, as shown in FIG. 21, a gate insulator 413, a semiconductor layer 414 and a second PR layer 440 are formed on the substrate 400 sequentially. The gate insulator 413 is deposited by the chemical vapor deposition (CVD) with a reaction gas. In particular, silane (SiH₄) and ammonia (NH₃) are used so as to form a silicon nitride (SiNₓ) structure. As shown in FIG. 22, a second mask (not shown) is used in another lithography and etching processes so as to obtain a semiconductor pattern 415.

Subsequently, as shown in FIG. 23, a source/drain (S/D) metal layer 410 and a third PR layer 441 are deposited over the substrate 400. Usually, the S/D metal layer is a multi-layer structure comprised of Mo/AlNd/Mo (tri-layer) or Ti/Al/Ti (Ti, titanium).

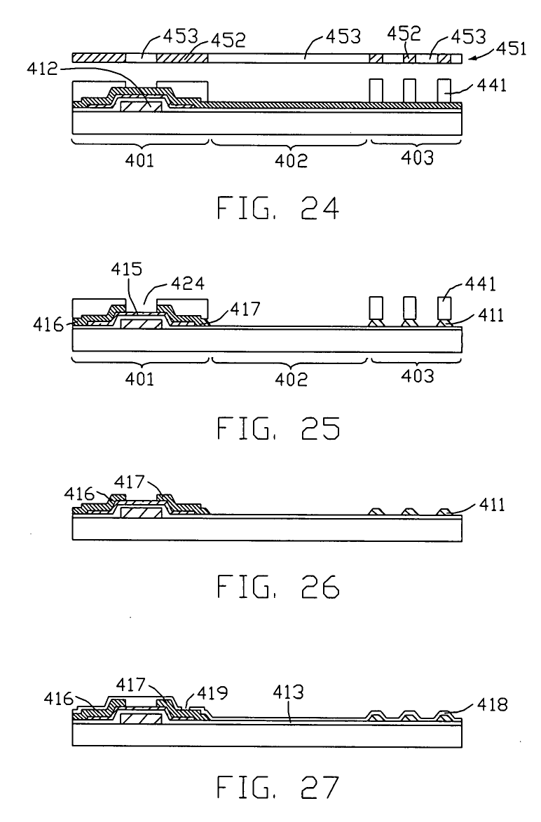

As shown in FIG. 24, a third mask 451 is utilized in another lithography process so as to define a predetermined pattern over the third PR layer 441 through the third mask 451. The third mask 451 includes a third light shielding area 452 and a third light transmission area 453. Corresponding to the TFT region 401 with the substrate 400, the third light transmission area 453 is substantially corresponding to the gate 412 area. The remaining portion of the third mask 451 within the TFT region 401 is the light shielding area 452. The portion of the third mask 451 corresponding to the transmission region 453 is all for light transmission area 453. Corresponding to the reflection region 403 with the substrate 400, the light shielding area 452 and the light transmission area 453 of the third mask 451 are set alternately.

After the exposing and developing processes, as shown in FIG. 25, a third PR pattern is transformed from the third mask 451. Consequently, the third PR pattern is treated as an etching mask that a source 416 and a drain 417 are formed within the TFT region 401, and a plurality of protrusions 411 are formed within the reflection region 403. A gap 424 is defined between the source 416 and the drain 417. Afterward, as shown in FIG. 26, the remaining third PR layer 441 is ashed so as to expose the source 416, the drain 417 and the protrusions 411.

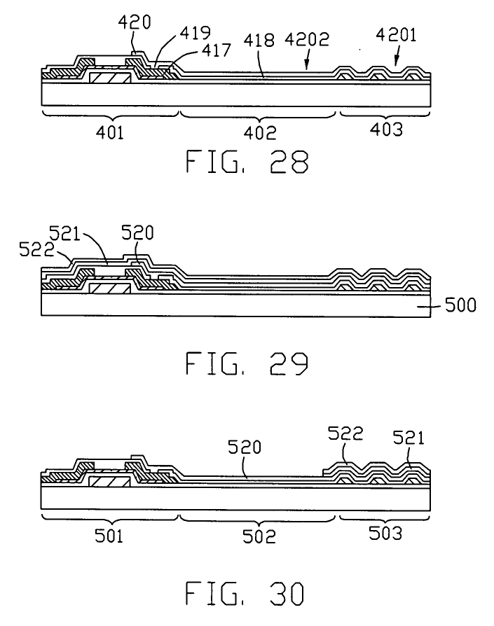

As shown in FIG. 27, a passivation layer 418 and a fourth PR layer (not shown) are deposited over the substrate 400. A fourth mask (not shown) is used during the lithography process and after the etching process drain 417 can be exposed through a contact hole 419. As shown in FIG. 28, a pixel electrode layer and a fifth PR layer are formed over the passivation layer 418 sequentially. The material of the pixel electrode layer can be chosen from ITO or IZO. A fifth mask (not shown) is utilized during the exposing process and after the developing and etching process, whereby a pixel electrode 420 can be formed. The pixel electrode 420 is electrically connected to the drain 417 through the contact hole 419 so as to define a reflection pixel electrode 4201 over the protrusion 411 within the reflection region 403 and a transmission pixel electrode 4202 within the transmission region 402. Due to the uneven surface of the reflection pixel electrode 4201 constructed by the protrusion 411 in the reflection region 403 that the index of the reflection pixel electrode 4201 can be promoted.

Referring to FIG. 29 and FIG. 30, these show cross-sectional views of part of a transflective type TFT substrate of an LCD device illustrating the manufacturing steps according to a fourth exemplary embodiment of the present invention. According to the above third embodiment, as shown in FIG. 29, the fourth embodiment further includes a buffer layer 521 and a reflection metal layer 522 deposited sequentially over a transparent insulating substrate 500. Consequently, as shown in FIGS. 29 and 30, a lithography process and an etching process are applied so as to define the buffer layer 521 and the reflection metal layer 522 upon the reflection region 503, and define a transmission pixel electrode 520 within the transmission region 502 and part of the TFT region 501.

As would be understood by a person skilled in the art, the foregoing preferred and exemplary embodiments are provided in order to illustrate principles of the present invention rather than limit the present invention. The above descriptions are intended to cover various modifications and similar arrangements and procedures included within the spirit and scope of the appended claims, which scope should be accorded the broadest interpretation so as to encompass all such modifications and similar structures and methods.

What is claimed is:

1. A method for fabricating a transflective liquid crystal display device, the method comprising:
providing a substrate defining a thin film transistor region, a transmission region, and a reflection region;
forming a first metal layer and a first photo-resist layer on the substrate sequentially;
applying an exposing process on the first photo-resist layer through a first mask and developing the first photo-resist layer;
etching the first metal layer through the developed first photo-resist layer so as to form a gate of a thin film transistor and a plurality of protrusions within the reflection region;
forming a gate insulator on the substrate;
forming a semiconductor pattern on the gate insulator within the thin film transistor region;
forming a source metal layer and a drain metal layer of the thin film transistor on the semiconductor pattern within the thin film transistor region;
forming a passivation layer on the substrate;
forming a contact hole through the passivation layer so as to expose the drain metal layer through the contact hole; and
forming a transmission pixel electrode within the transmission region and a reflection pixel electrode within the reflection region.

2. The method as claimed in claim 1, wherein the first metal layer comprises stacked multi-layers, and an etch rate of each of the stacked multi-layers increases from bottom to top.

3. The method as claimed in claim 2, wherein a profile of each of the gate and the protrusions is a frustum structure.

4. The method as claimed in claim 2, wherein the stacked multi-layers from top to bottom comprise molybdenum, and aluminum-neodymium alloy.

5. The method as claimed in claim 1, wherein the first mask comprises a plurality of light shielding areas and a plurality of light transmission areas, one of the light shielding areas corresponds to the thin film transistor region, and part of the light transmission areas and light shielding area are set alternately corresponding to the reflection region.

6. The method as claimed in claim 1, further comprising forming a buffer layer, a reflection metal layer, and a second photo-resist layer over the substrate sequentially and applying a lithography and etching process to the reflection metal layer, the reflection metal layer and the second photo-resist layer so as to expose the transmission pixel electrode within the transmission region and obtain the reflection metal electrode within the reflection region.

7. The method as claimed in claim 6, wherein the buffer layer is made of molybdenum or titanium.

8. The method as claimed in claim 6, wherein the reflection metal layer is made of aluminum, argentums, or aluminum-neodymium alloy.

9. A method for fabricating a transflective liquid crystal display device, the method comprising:
providing a substrate defining a thin film transistor region, a transmission region, and a reflection region;
forming a gate metal layer on the substrate within the thin film transistor region;
forming a gate insulator on the substrate;
forming a semiconductor pattern on the gate insulator within the thin film transistor region;
forming a first metal layer and a first photo-resist layer over the substrate sequentially;
exposing the first photo-resist layer through a first mask and developing the first photo-resist layer;
etching the first metal layer through the developed first photo-resist layer so as to form a source and a drain of the thin film transistor region and a plurality of protrusions within the reflection region;
forming a passivation layer over the substrate;
forming a contact hole through the passivation layer so as to expose the drain through the contact hole; and
forming a transmission pixel electrode within the transmission region and a reflection pixel electrode within the reflection region.

10. The method as claimed in claim 9, wherein the first metal layer comprises stacked multi-layers.

11. The method as claimed in claim 10, wherein the stacked multi-layers from top to bottom comprise titanium, aluminum, and titanium.

12. The method as claimed in claim 10, wherein the stacked multi-layers from top to bottom comprise molybdenum, aluminum-neodymium alloy, and molybdenum.

13. The method as claimed in claim 10, wherein the stacked multi-layers from top to bottom comprise molybdenum, aluminum, and molybdenum.

14. The method as claimed in claim 9, wherein the first mask comprises a plurality of light shielding areas and a plurality of light transmission areas, one of the light shielding areas corresponds to the thin film transistor region, and part of the light transmission areas and light shielding area are set alternately corresponding to the reflection region.

15. The method as claimed in claim 9, further comprising forming a buffer layer, a reflection metal layer, and a second photo-resist layer over the substrate sequentially and applying a lithography and etching process to the reflection metal layer, the reflection metal layer and the second photo-resist layer so as to expose the transmission pixel electrode within the transmission region and obtain the reflection metal electrode within the reflection region.

16. The method as claimed in claim 15, wherein the buffer layer is made of molybdenum or titanium.

17. The method as claimed in claim 9, wherein the reflection metal layer is made of aluminum, argentums or aluminum-neodymium alloy.
